(19) United States
(12) Patent Application Publication
(10) Pub. No.: US 2014/0010263 A1
(43) Pub. Date: Jan. 9, 2014

(54) TEMPERATURE DISTRIBUTION DETECTING DEVICE AND METHOD

(71) Applicant: Azbil Corporation, Tokyo (JP)

(72) Inventors: Tomoki HOSOI, Tokyo (JP); Mitsuhiro HONDA, Tokyo (JP)

(21) Appl. No.: 13/937,730

(22) Filed: Jul. 9, 2013

(30) Foreign Application Priority Data
Jul. 9, 2012 (JP) 2012-153230

(51) Int. Cl. G01K 13/00

(52) U.S. Cl. CPC G01K 13/00
USPC 374/137

(57) ABSTRACT

A temperature distribution detecting device has a detected temperature acquiring portion that acquires detected temperatures from each individual thermopile array sensor, a temperature difference calculating portion that calculates a temperature difference between detected temperatures, for each combination, between the two thermopile array sensors that structure the combination, a relative error estimating portion that establishes, for each combination, equations indicating the relationships between the relative error between a reference thermopile array sensor selected as a reference from among the thermopile array sensors and each of the thermopile array sensors and temperature differences calculated for each individual combination, and establishes these equations in a system and solving through the least-squares method to estimate the relative errors, and a detected temperature correcting portion that corrects, based on the individual relative errors, the detected temperatures by the individual thermopile array sensors, to generate temperature distribution data for the space.

### CROSS REFERENCE TO RELATED APPLICATION

This application claims priority under 35 U.S.C. §119 to Japanese Patent Application No. 2012-153230, filed on Jul. 9, 2012, the entire content of which being hereby incorporated herein by reference.

### FIELD OF TECHNOLOGY

The present invention relates to a temperature distribution detecting technology, and, in particular, relates to a temperature distribution detecting technology for detecting indoor temperature distributions using a plurality of thermopile array sensors.

### BACKGROUND

In lighting systems, technologies are being researched by which to achieve energy conservation through identifying locations wherein individuals are present from temperature distributions within a space, to turn ON lighting in the vicinities thereof and to turn OFF lighting in areas wherein no individuals are present. Moreover, in air-conditioning systems there is research into technologies for using distributed system heat flow analysis techniques to estimate, from temperature distributions within a space and from target temperatures at locations within that space, air vent speeds and air vent temperatures for the individual air vents within the space.

In this way, in control systems for controlling a space, temperature distribution detecting devices are used when detecting temperature distributions within the space.

Conventionally, in such temperature distribution detecting devices thermopile array is have been used as sensors for no-contact two-dimensional detection of the temperature distribution of a target object. See, for example, Japanese Unexamined Patent Application Publication 2004-170375. A thermopile array is an arrangement, in the form of an array on a semiconductor substrate, for example, of detecting elements made from thermal infrared sensors, specifically, thermopiles, for producing a thermal electromotive force in accordance with the amount of incident energy when incident infrared radiation is received from a target object. The thermopile array sensor enables simultaneous detection of a temperature distribution over a broad range, such as a space.

However, in this conventional technology, there is variability in the detected temperatures between thermopile array sensors, and thus there is a problem in that it is not possible to detect the temperature distribution within the space accurately.

That is, because the thermopile array sensor is structured from a plurality of detecting elements that are arranged in the form of a matrix, to some degree detection error between the individual detecting elements within a single thermopile array sensor is corrected. When each of the detecting elements is on a semiconductor substrate, in particular, the detection error relative to each other is low.

However, due to factors in the manufacturing process, or the like, there may be detection errors of about 2 or 3° C. between thermopile array sensors, which are large when compared to the detection errors between detecting elements. Because of this, when multiple thermopile array sensors are used to detect the temperature distribution within a space, in a region corresponding to a given thermopile array sensor temperatures that are different from the surroundings will be detected, preventing accurate detection of the temperature distribution within the space.

The present invention is to solve such a problem, and an aspect thereof is to provide a temperature distribution detecting technology wherein the detection error between thermopile array sensors can be controlled to detect the temperature distribution within the space accurately.

### SUMMARY

In order to achieve such aspect, a temperature distribution detecting device according to the present invention has a storing portion that stores a combination of two adjacent thermopile array sensors from among a plurality of thermopile array sensors disposed in a space for which a temperature distribution is to be detected, a detected temperature acquiring portion that acquires detected temperatures from each individual thermopile array sensor, a temperature difference calculating portion that calculates a temperature difference between detected temperatures, for each combination, between the two thermopile array sensors that structure the combination, a relative error estimating portion that establishes, for each combination, equations indicating the relationships between the relative error between a reference thermopile array sensor selected as a reference from among the thermopile array sensors and each of the thermopile array sensors and temperature differences calculated for each individual combination, and establishes these equations in a system and solving through the least-squares method to estimate the relative errors, and a detected temperature correcting portion that corrects, based on the individual relative errors, the detected temperatures by the individual thermopile array sensors, to generate temperature distribution data for the space.

Moreover, in one form of the temperature distribution detecting device according to the present invention, the detected temperature acquiring portion acquires the individual detected temperatures, detected by the individual detecting elements within each thermopile array sensor, from each individual thermopile array sensor, and the temperature difference calculating portion, when calculating the temperature difference for each combination, calculates a representative detected temperature in an overlapping region wherein the temperature detecting ranges of thermopile array sensors that are combined partially overlap each other, through statistical processes on the individual detected temperatures acquired from the applicable thermopile array sensor, for each individual thermopile array sensor, and then calculates a temperature difference between the representative detected temperatures between the two thermopile array sensors that structure the combination.

A temperature distribution detecting method according to the present invention includes a storing step of storing by a storing portion a combination of two adjacent thermopile array sensors from among a plurality of thermopile array sensors disposed in a space for which a temperature distribution is to be detected, a detected temperature acquiring step of acquiring by a detected temperature acquiring portion detected temperatures from each individual thermopile array sensor, a temperature difference calculating step of calculating by a temperature difference calculating portion a temperature difference between detected temperatures, for each combination, between the two thermopile array sensors that structure the combination, a relative error estimating step of establishing by a relative error estimating portion, for each combination, equations indicating the relationships between the relative error between a reference thermopile array sensor selected as a reference from among the thermopile array sensors and each of the thermopile array sensors and temperature differences calculated for each individual combination, and establishing these equations in a system and solves the system through the least-squares method to estimate the relative errors, and a detected temperature correcting step of correcting by a detected temperature correcting portion, based on the individual relative errors, the detected temperatures by the individual thermopile array sensors, to generate temperature distribution data for the space.

The present invention makes it possible to obtain a temperature distribution wherein relative errors of a thermopile array sensor relative to a reference thermopile array sensor have been corrected, thus making it possible to detect the distribution of temperatures accurately across the entire space.

### BRIEF DESCRIPTION OF THE DRAWINGS

FIG. 1 is a block diagram illustrating a structure of a temperature distribution detecting device.

FIG. 2 is an example of an installation of thermopile array sensors within a space.

FIG. 3 is an explanatory diagram illustrating detecting ranges of thermopile array sensors.

FIG. 4 is an explanatory diagram illustrating a combination of thermopile array sensors.

FIG. 5 is a structural example of combination data.

FIG. 6 is an explanatory diagram illustrating the relationship between the relative error and the temperature error.

FIG. 7 is a flowchart for a temperature distribution detecting procedure.

FIG. 8 is an example of acquisition of detected temperatures.

FIG. 9 is an example of calculation of representative detected temperatures.

FIG. 10 is an example of relative error data.

### DETAILED DESCRIPTION

The principle of the present invention will be explained first.

When a plurality of thermopile array sensors is used to detect the temperature distribution within a space, the detection error between these thermopile array sensors will produce variability in the temperature distribution within the space.

Here, when detecting a temperature distribution within a space, the point is to ascertain the differences between the relatively high and low temperatures across a wide range within the space, that is, to ascertain a relative temperature distribution, and the main objective is not that of detecting accurate temperatures in each area, that is, not to detect an absolute temperature distribution. For example, in a lighting system wherein the locations wherein people are present are identified from the temperature distribution within a space, all that is necessary is to obtain a relative temperature differences between the locations wherein people are present and the rest of the area wherein people are not.

Moreover, if the relative temperature distribution within a space can be understood accurately, then it would be possible to ascertain with high accuracy the temperatures at all locations within the space by comparing the detected temperatures obtained by a thermopile array sensor at one location, anywhere within the space, to the actual temperature measured by a temperature gauge other than a thermopile array sensor, and possible to do so if the temperature detecting accuracy of a reference thermopile array sensor, described below, is high, to produce an absolute temperature distribution. Doing so enables use even in air-conditioning systems that use the distributed system heat flow analysis technique.

The present invention focuses on a distinctive feature of this type of temperature distribution detector, to estimate the relative detection error between thermopile array sensors that are installed within a space, that is, to estimate the relative errors, and to correct the detected temperatures, obtained from the individual thermopile array sensors, based on relative errors.

Here, when estimating the relative errors of all of these thermopile array sensors, it is necessary to identify the relationships between the relative errors for relative errors in relation to the detected temperatures from a reference thermopile array sensor that has been selected as a reference, to estimate relative errors wherein these relationships are satisfied with little error.

The present invention focuses on how expressing the temperature differences in the detected temperatures that can be measured between adjacent thermopile array sensors as relative errors that are variables produces extremely simple equations, and on how the relationships between the relative errors can be identified by an equation that minimizes the error in these equations, where, for each of the temperature differences calculated from detected temperatures that are actually measured, that is, for each combination of adjacent thermopile array sensors, an equation is produced, and these equations are formed into a system of equations and solved through the least-squares method to estimate the relative error for each individual thermopile array sensor.

A form for carrying out the present invention will be explained next in reference to the figures.

### Temperature Distribution Detecting Device

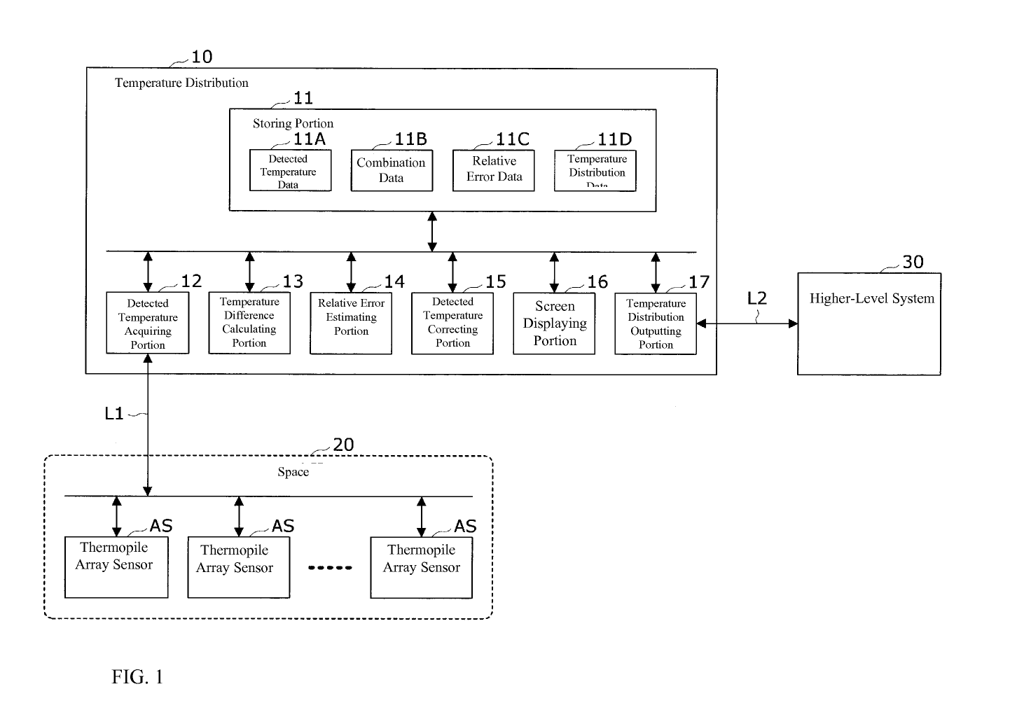

First a temperature distribution detecting device 10 according to an example will be explained in reference to FIG. 1. FIG. 1 is a block diagram illustrating a structure for a temperature distribution detecting device.

The temperature distribution detecting device 10, as a whole, is structured from an information processing device such as a server device, a personal computer controller, or the like, and has a function for estimating positional shift factors indicating the relative errors of the detection temperatures of individual thermopile array sensors AS based on the respective detected temperatures obtained through a communication circuit L1 from each of a plurality of thermopile array sensors AS installed within a space 20 that is the subject of temperature detection, and a function for generating temperature distribution data in the space 20 by correcting the detected temperatures by these relative errors.

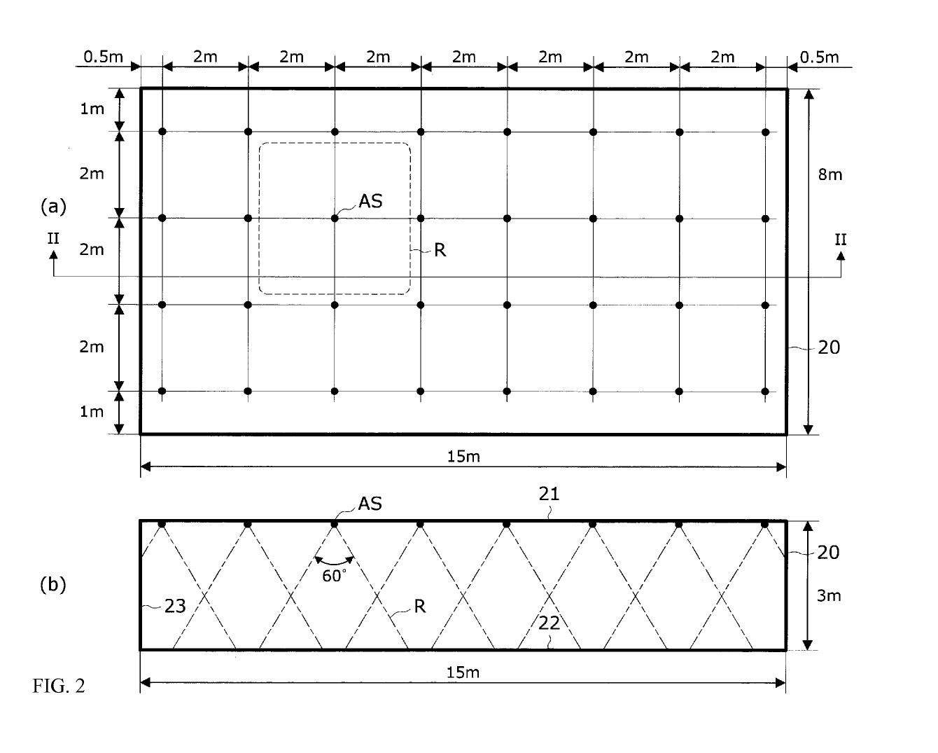

FIG. 2 is an example of an installation of thermopile array sensors within a space, where FIG. 2 (a) is a plan view diagram of the space, and FIG. 2 (b) is a cross-sectional diagram along the section II-II in FIG. 2 (a). Here 32 thermopile array sensors AS are installed in a grid with equal spacing on the ceiling 21 of a rectangular space 20. In the space 20, the width (in the long direction) is 15 m, the depth (in the short direction) is 8 m, and the height is 3 m. The thermopile array sensors AS are disposed at the intersections of a grid with 2 m spacing in the lengthwise and crosswise directions, and each has a square-shaped detecting range R in the vertical direction from the ceiling 21 to the floor 22.

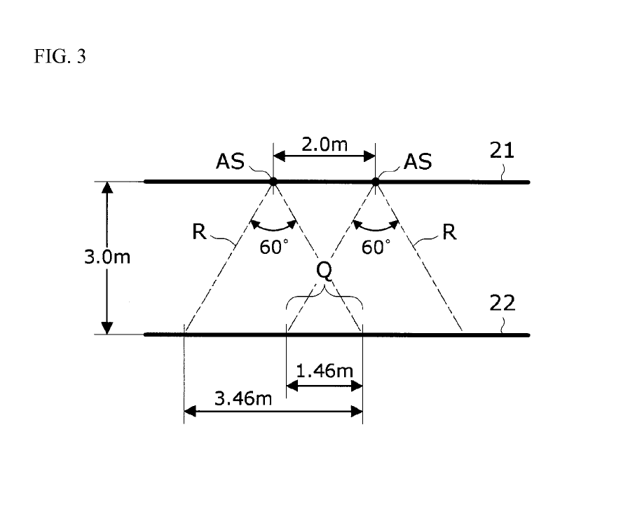

FIG. 3 is an explanatory diagram illustrating the detecting ranges of the thermopile array sensors. In this example, the spacing with which the thermopile array sensors AS are installed is 2 m, the height of the space 20 is 3 m, and the field of view of the detecting ranges R is 60°. Because of this, the detecting range R, on the floor 22, is a square that is 3.46 m square, producing an overlap region Q of a width of 1.46 m for the overlapping portion of the detecting ranges R between adjacent thermopile array sensors AS. While here the explanation is for an example wherein the detecting range R is formed in a direction that is vertical from the ceiling 21 to the floor 22, it instead may be formed at an angle rather than being vertical. Moreover, the thermopile array sensors AS may be disposed on the floor 22 or the wall 23, rather than on the ceiling 21.

The temperature distribution detecting device 10 has, as its primary functional portions, a storing portion 11, a detected temperature acquiring portion 12, a temperature difference calculating portion 13, a relative error estimating portion 14, a detected temperature correcting portion 15, a screen displaying portion 16, and a temperature distribution outputting portion 17.

The storing portion 11 is made from a storing device, such as a hard disk or a semiconductor memory, and has the function of storing the various types of information and programs used in the temperature distribution detecting procedure.

The main processing information stored in the storing portion 11 includes detected temperature data 11A, combination data 11B, relative error data 11C, and temperature distribution data 11D.

The detected temperature data 11A is the detected temperatures detected by the individual detecting elements within the thermopile array sensor AS, for each individual thermopile array sensor AS installed within the space 20. These detected temperatures are acquired through data communication with each of the thermopile array sensors AS through the communication circuit L1 by the detected temperature acquiring portion 12, and are stored in the storing portion 11.

The combination data 11B is data indicating a combination of two adjacent thermopile array sensors AS, from among all the thermopile array sensors AS, and is set in advance based on design data, such as the installation locations of the thermopile array sensors AS, and stored in the storing portion 11.

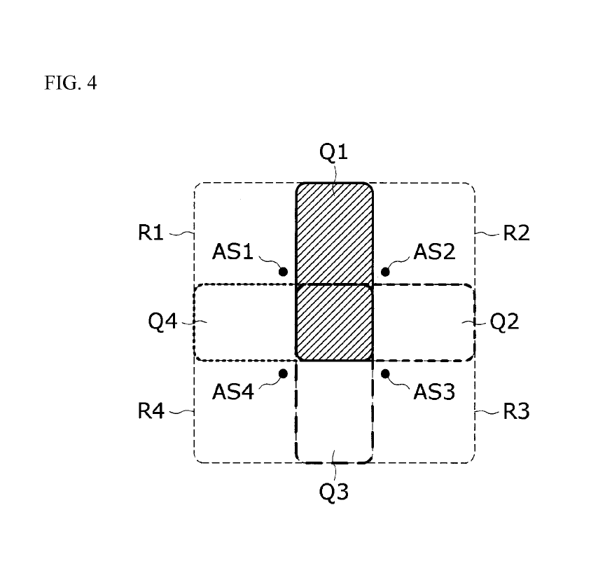

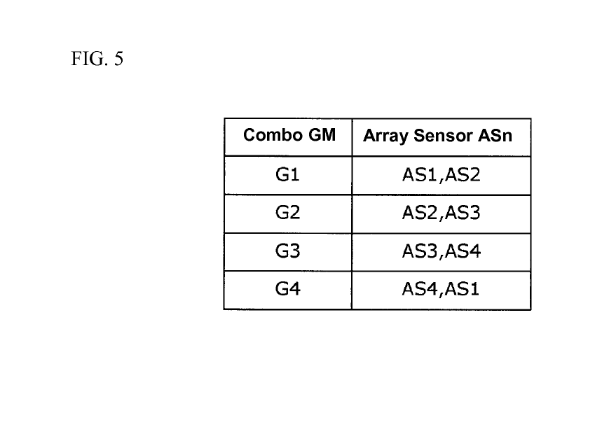

FIG. 4 is an explanatory diagram illustrating a combination of thermopile array sensors. FIG. 5 is a structural example of combination data. Here for thermopile array sensors AS1, AS2, AS3, and AS4 are disposed with the positional relationships explained in FIG. 3.

These thermopile array sensors AS1, AS2, AS3, and AS4 have their respective detecting ranges R1, R2, R3, and R4, producing overlapping regions on the floor 22. For example, in the respective R1 and R2 of AS1 and AS2, there is a rectangular overlapping region Q1, and in a portion of the respective R2 and R3 of AS2 and AS3 there is a rectangular overlapping region Q2. Similarly, in the respective R3 and R4 of AS3 and AS4, there is a rectangular overlapping region Q3, and in a portion of the respective R4 and R1 of AS4 and AS1 there is a rectangular overlapping region Q4.

In FIG. 5, of these thermopile array sensors AS1, AS2, AS3, and AS4, the IDs of two adjacent thermopile array sensors are combined and set as a Gm. Here the combination of AS1 and AS2, the combination of AS2 and AS3, the combination of AS3 and AS4, and the combination of AS4 and AS1 are set, respectively, as G1, G2, G3, and G4. Note that although, when it comes to R1 and R3, and when it comes to R2 and R4, these overlap in the overlapping region in the center, the overlapping surface areas when compared to the areas of these R1, R2, R3, and R4 are small, and it can be inferred that they will have little effect on the temperatures of each other, and so these combinations are not set.

Moreover, while in this example, combinations are set for those thermopile array sensors AS having detecting ranges R that mutually overlap, depending on the setup of a thermopile array sensor AS, the detecting range R may not overlap. In such a case, a combination with a thermopile array sensor AS that is adjacent to the installation locations should be set.

The relative error data 11C is data indicating the temperature discrepancy that should be corrected for the detected temperatures detected by the thermopile array sensor AS, for each individual thermopile array sensor AS. The relative error is defined by the temperature difference between the temperatures detected by a reference thermopile array sensor, selected as a reference from among all of the thermopile array sensors AS, and another thermopile array sensor, and is estimated by the relative error estimating portion 14, and stored in the storing portion 11.

The temperature distribution data 11D is data indicating the temperature distribution in the space 20 as a whole, generated through correcting the detected temperatures, detected by the individual thermopile array sensors AS, by the respective relative errors, and is generated by the detected temperature correcting portion 15 and stored in the storing portion 11.

The detected temperature acquiring portion 12 has a function for acquiring detected temperatures, detected by the detecting elements within the thermopile array sensors AS, through performing data communication with each individual thermopile array sensor AS through the communication circuit L1, and a function for storing, into the storing portion 11, the detected temperature data 11A including these detected temperatures.

The temperature difference calculating portion 13 has a function for extracting, from the detected temperature data 11A of the storing portion 11, the detected temperatures detected by the thermopile array sensor AS, for each individual thermopile array sensor AS, and for performing statistical processes to calculate the average value, maximum value, minimum value, and the like of the detected temperatures, to calculate a representative detected temperature in the overlapping region wherein portions of the temperature detecting ranges of thermopile array sensors that form a pair overlap each other, and has a function for calculating, for each combination wherein the combination data 11B is registered in the storing portion 11, the temperature difference between the representative detected temperatures for the two thermopile array sensors AS that form the combination.

The relative error estimating portion 14 has a function for generating, for each combination, an equation indicating the relationship between the relative error between the reference thermopile array sensor that was selected as the reference from among the thermopile array sensors AS and another thermopile array sensor that is not the reference thermopile array sensor, and the temperature difference calculated for each combination by the temperature difference calculating portion 13, a function for forming these equations into a system of equations and solving through the least-squares method to estimate the relative errors, and a function for storing, in the storing portion 11, the relative error data 11C that is made up of the relative errors that have been obtained.

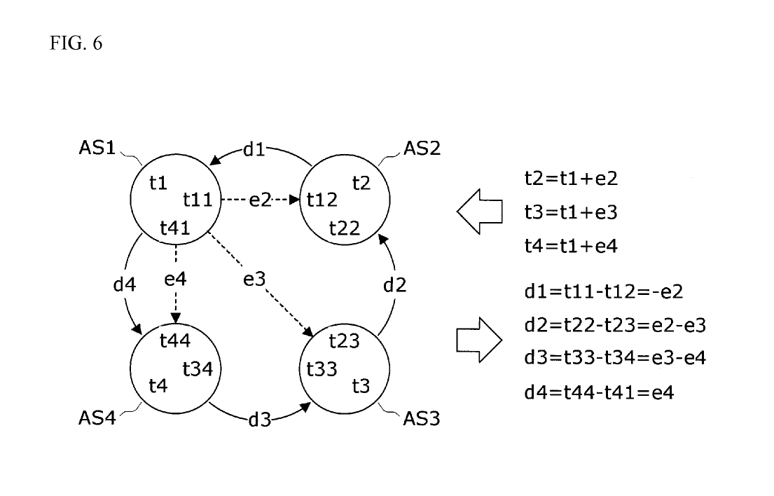

FIG. 6 is an explanatory diagram illustrating the relationship between the relative error and the temperature error. In the example of the combinations of the thermopile array sensors AS1, AS2, AS3, and AS4, illustrated in FIG. 4 and FIG. 5, if the thermopile array sensor AS1 is defined as the reference thermopile array sensor, then the relative errors between the reference thermopile array sensor AS1 and the other thermopile array sensors AS2, AS3, and AS4 are defined, respectively, as e1, e2, e3, and e4. Consequently, if the representative detection temperatures of the thermopile array sensors AS1, AS2, AS3, and AS4 are defined as t1, t2, t3, and t4, then there will be the relationships of t2=t1+e2, t3=t1+e3, and t4=t1+e4. Consequently, if the temperature distribution within the space 20 were uniform, then t2 would indicate a temperature that is lower than t1 by e2. Consequently, if the temperature distribution within the space 20 were uniform, then t2 would indicate a temperature that is higher than t1 by e2. Thus, the relative error of t2 would be corrected by adding e2 to t2. Thus, the relative error of t2 would be corrected by subtracting e2 from t2.

Here if the representative detected temperatures for the overlapping region Q1 between the thermopile array sensors AS1 and AS2 that structure the combination G1 are, respectively, t11 and t12, then the temperature difference d1 between AS1 and AS2 is expressed as d1=t11−t12, and when this is expressed as the relative error, d1=t11−t12=−e2. Moreover, if the representative detected temperatures for the overlapping region G2 between the thermopile array sensors AS2 and AS3 that structure the combination Q2 are, respectively, t22 and t23, then the temperature difference d2 between AS2 and AS3 is expressed as d2=t22−t23, and when this is expressed as the relative error, d2=t22−t23=e2−e3.

Similarly, if the representative detected temperatures for the overlapping region G3 between the thermopile array sensors AS3 and AS4 that structure the combination Q3 are, respectively, t33 and t34, then the temperature difference d3 between AS3 and AS4 is expressed as d3=t33−t34, and when this is expressed as the relative error, d3=t33−t34=e3−e4. Similarly, if the representative detected temperatures for the overlapping region G4 between the thermopile array sensors AS4 and AS1 that structure the combination Q4 are, respectively, t44 and t41, then the temperature difference d4 between AS4 and AS1 is expressed as d4=t44−t41, and when this is expressed as the relative error, d4=t44−t41=e4.

In this way, for the four temperature differences d1, d2, d3, and d4 that can be detected as numeric values, four equations can be constructed using the three variables e2, e3, and e4 with unknown values, for each temperature difference, that is, for each combination. Consequently, the values for the variables e2, e3, and e4, that is, the relative errors, can be estimated by setting up these equations as a system of equations and solving through the least-squares method. Note that a well-known technique may be used for the calculating procedure for the least-squares method.

In these equations, typically a weight w of a thermopile array sensor AS is introduced for a relative error e, to express the equations as a matrix equation. If the temperature differences corresponding to a combinations Gm (where m is an integer between 1 and M) is defined as dm, the relative error corresponding to the thermopile array sensor ASn (where n is an integer between 1 and N) is defined as en, and the weight of the thermopile array sensor ASn relative to the relative error en at the temperature difference dm for the combination Gm is defined as Wmn, then the equations above can be expressed by the following matrix Equation (1):

$$\begin{matrix}[ Expression 1 ] & \\ [ \begin{matrix}{d}_{1} \\ {d}_{2} \\ ⋮ \\ {d}_{M}\end{matrix} ] = [ \begin{matrix}{w}_{12} & {w}_{13} & … & {w}_{1 N} \\ {w}_{22} & {w}_{23} & … & {w}_{2 N} \\ ⋮ & ⋮ & ⋱ & ⋮ \\ {w}_{M 2} & {w}_{M 3} & … & {w}_{MN}\end{matrix} ] [ \begin{matrix}{e}_{2} \\ {e}_{3} \\ ⋮ \\ {e}_{N}\end{matrix} ] & ( 1 )\end{matrix}$$

In Equation (1), each weight Wmn is a value of either 1, −1, or 0. Here, in the equation for calculating a temperature difference dm, w=1 for a thermopile array sensor ASn wherein the detected temperature tn has a positive sign, and w=−1 for a thermopile array sensor ASn wherein the detected temperature tn has a negative sign. Moreover, for a thermopile array sensor ASn that was not used in calculating dm, w=0.

In Equation (1), if the matrix of temperature differences dm is defined as D, the matrix of weights Wmn is defined as W, and the matrix of relative errors en is defined as E, then Equation (1) can be expressed as D=WE.

Consequently, the estimation result E′ for E through the least-squares method typically is calculated as E′=(WTW)−1WTD. Here WT is the transposed matrix of W.

The detected temperature correcting portion 15 has a function for producing the temperature distribution data 11D for the space 20 by correcting each of the detected temperatures obtained from the thermopile array sensors AS, obtained from the detected temperature data 11A of the storing portion 11, based on the relative errors of the applicable thermopile array sensors AS, similarly obtained from the relative error data 11C of the storing portion 11, for each individual thermopile array sensor AS, and a function for storing, in the storing portion 11, the temperature distribution data 11D that is produced.

The screen displaying portion 16 has a screen displaying device, such as an LCD, and has a function for reading out the temperature distribution data 11D of the storing portion 11 and displaying a screen.

The temperature distribution outputting portion 17 has a function for outputting, to a higher-level system 30, the temperature distribution data 11D, read out from the storing portion 11, through performing data communication with the higher-level system 30, such as a lighting system or air-conditioning system, or a building control system, or the like, through a communication circuit L2.

Of these functional portions, the detected temperature acquiring portion 12, the temperature difference calculating portion 13, the relative error estimating portion 14, the detected temperature correcting portion 15, the screen displaying portion 16, and the temperature distribution outputting portion 17 are embodied through a calculation processing portion wherein a program of the storing portion 11 is executed on a CPU. Note that this program is read out in advance from an external device that is connected through a communication circuit, or from a recording medium (neither of which are shown) and stored in the storing portion 11.

### Operation of the Present Example

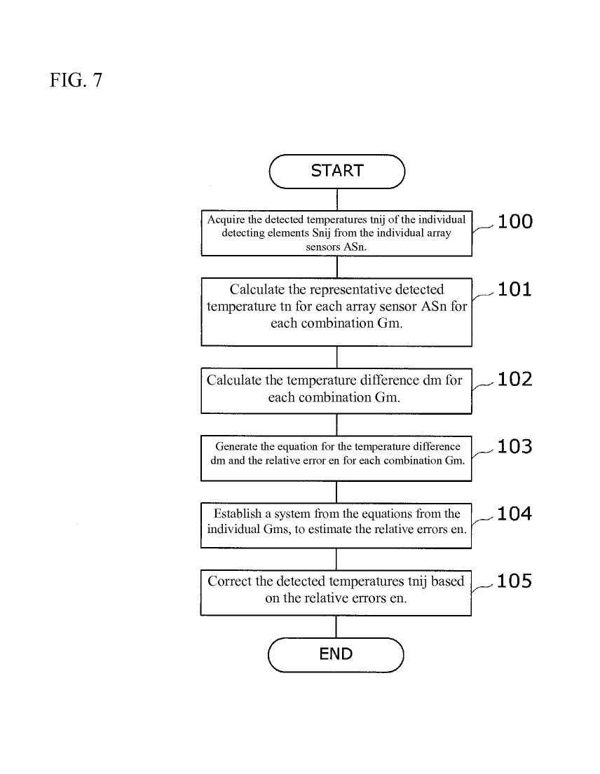

The operation of the temperature distribution detecting device 10 according to the present example will be explained next in reference to FIG. 7. FIG. 7 is a flowchart showing the temperature distribution identifying procedure.

The temperature distribution detecting device 10 either periodically or in response to an execution instruction from the outside executes the temperature distribution detecting procedure of FIG. 7. Here it is assumed that N thermopile array sensors ASn (where n is an integer between 1 and N) are installed within a space 20, and, for these thermopile array sensors ASn, M combinations Gm (where m is an integer between 1 and M) are set. Note that I×J detecting elements are arranged in the form of a grid in each thermopile array sensor ASn. Moreover, the relative error of an individual thermopile array sensor ASn is defined as en, and the temperature difference in an individual combination Gm is defined as dm.

First the detected temperature acquiring portion 12 obtains, from the individual thermopile array sensors ASn that are installed within the space 20, the detected temperatures tnij detected by the individual detecting elements Sij within the given thermopile array sensor ASn, and stores them in the storing portion 11 as detected temperature data 11A (Step 100).

Following this, the temperature difference calculating portion 13, based on the detected temperature data 11A of the storing portion 11 calculates the respective representative detected temperatures tmn that represent the mutually overlapping area for the two thermopile array sensors AS and that structure a combination Gm, for each combination Gm recorded in the combination data 11B of the storing portion 11 (Step 101), and, for each combination Gm, calculates the temperature difference dm between the representative detected temperatures tmn of the two thermopile array sensors ASn that structure the given combination Gm (Step 102).

Following this, the relative error estimating portion 14 generates, for each combination Gm, an equation representing the relationship between the relative error en of the individual thermopile array sensor ASn and the temperature difference dm calculated for each combination Gm by the temperature difference calculating portion 13 (Step 103), and establishes these equations as a system, which it solves through the least-squares method to estimate the relative errors en, and stores them, as a relative error data 11C, in the storing portion 11 (Step 104).

Thereafter, the detected temperature correcting portion 15, for each thermopile array sensor ASn, based on the relative error en obtained from the relative error data 11C of the storing portion 11, corrects the detected temperatures tnij, obtained by the applicable thermopile array sensor AS, obtained similarly from the detected temperature data 11A of the storing portion 11, to produce temperature distribution data 11D for the space 20, and stores it in the storing portion 11 (Step 105), to complete the series of procedures for detecting the temperature distribution.

As a result, the temperature distribution data 11D is read out from the storing portion 11 and displayed on the screen by the screen displaying portion 16, or outputted to the higher-level system 30 by the temperature distribution outputting portion 17.

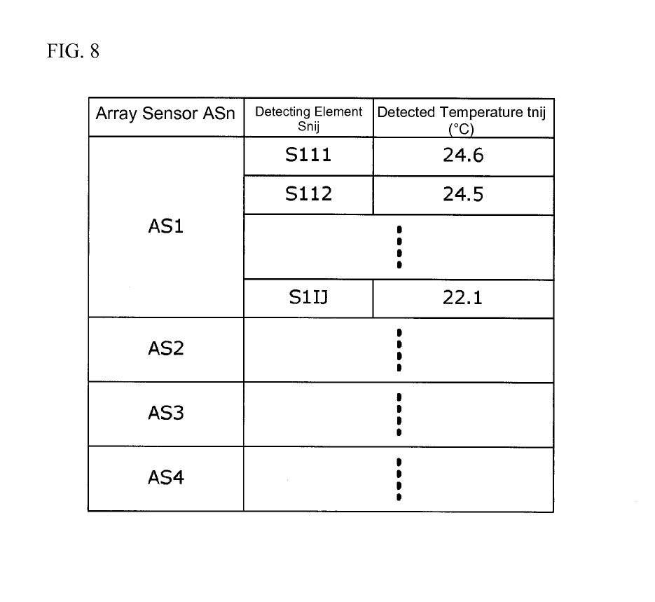

FIG. 8 is an example of acquisition of detected temperatures. As explained using FIG. 6, here four thermopile array sensors ASn (where n is an integer between 1 and 4) are disposed within the space 20, and detected temperatures tnij are obtained from the individual thermopile array sensors ASn.

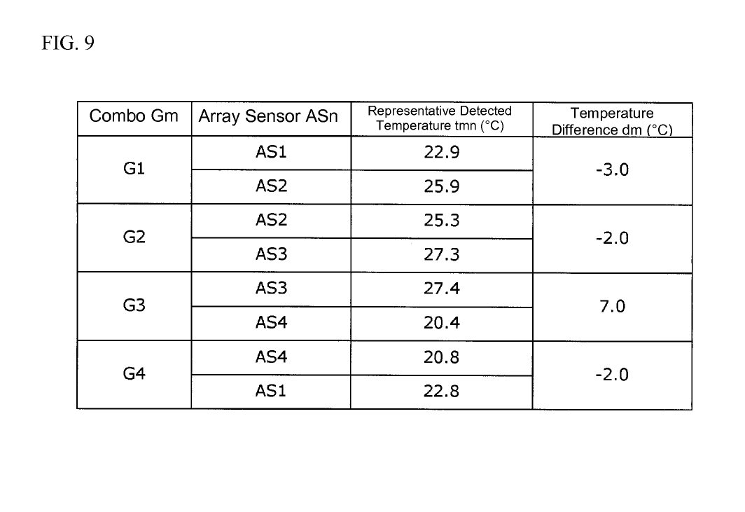

FIG. 9 is an example of calculation of representative detected temperatures. Here the representative detected temperatures tmn that represent the mutually overlapping region of the two thermopile array sensors AS and that structure the applicable combination Gm are calculated, for each combination Gm based on the detected temperatures tnij of FIG. 8, and the temperature difference dm is calculated from the representative detected temperatures tmn. For example, for the combination G1, for the thermopile array sensors AS1 and AS2 that structure the combination G1, the representative detected temperatures are calculated as t11=22.9° C. and t12=25.9° C., and, from their difference, the temperature difference d1=t11−t12=−3.0° C. for the combination G1. Similarly, the temperature differences for the combinations G2, G3, and G4 are calculated, respectively, as d2=−2.0° C., d3=7.0° C., and d4=−2.0° C.

After this, equations using the relative errors en are generated for each temperature difference dm, and expressed as the following matrix Equation (2):

$$\begin{matrix} [ Expression 2 ] & \\ [ \begin{matrix}- 3 \\ - 2 \\ 7 \\ - 2\end{matrix} ] = [ \begin{matrix}- 1 & 0 & 0 \\ 1 & - 1 & 0 \\ 0 & 1 & - 1 \\ 0 & 0 & 1\end{matrix} ] [ \begin{matrix}{e}_{2} \\ {e}_{3} \\ {e}_{4}\end{matrix} ] & ( 2 )\end{matrix}$$

This Equation (2) is rewritten as was Equation (1), described above, to produce the following Equation (3) that expresses the estimated relative errors e:

$$\begin{matrix}[ Expression 3 ] & \\ [ \begin{matrix}{e}_{2} \\ {e}_{3} \\ {e}_{4}\end{matrix} ] = [ \begin{matrix}3 \\ 5 \\ - 2\end{matrix} ] & ( 3 )\end{matrix}$$

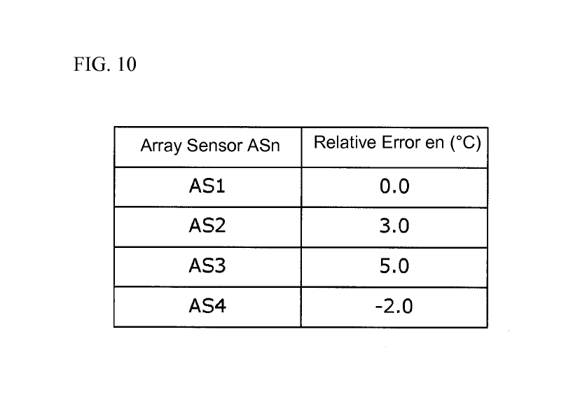

FIG. 10 is an example of relative error data.

Through this, the individual relative errors are calculated as e1=0.0° C., e2=3.0° C., e3=5.0° C., and e4=−2.0° C. Consequently, in FIG. 8, 3.0° C. is added to each of the detected temperatures t2ij, detected by the individual detecting elements S2ij of the thermopile array sensor AS2, 5.0° C. is added to each of the detected temperatures t3ij, detected by the individual detecting elements S3ij of the thermopile array sensor AS3, and 2.0° C. is subtracted from each of the detected temperatures t4ij, detected by the individual detecting elements S4ij of the thermopile array sensor AS4.

In this way, in the present example, the detected temperature acquiring portion 12 acquires detected temperatures from each of the individual thermopile array sensors AS, the temperature difference calculating portion 13 calculates temperature differences of the detected temperatures between two thermopile array sensors that structure a combination, for each individual combination, the relative error estimating portion 14 estimates the relative errors by generating, for each combination, an equation indicating the relationship between the relative error between a reference thermopile array sensor and, for each thermopile array sensor, the temperature difference calculated for each combination, and sets up these equations in a system, which it solves through the least-squares method, and the detected temperature correcting portion 15, based on the individual relative errors, corrects the detected temperatures from each of the thermopile array sensors, to generate the temperature distribution data 11D for the space 20.

This makes it possible to produce temperature distribution data 11D wherein the relative errors of the thermopile array sensors relative to the reference thermopile array sensor are corrected, making it possible to detect the distribution of temperatures with excellent accuracy across the entirety of the space 20.

Moreover, in the present example, when identifying the relationships between the individual relative errors, equations are generated indicating the relationships between the relative errors between the individual thermopile array sensors and the temperature differences calculated for each combination, and thus these are extremely simple equations, making it possible to identify the relationship between the relative errors through an equation that minimizes the error included in the equations, making it possible to reduce the calculation processing overhead in the least-squares method and possible to reduce the time required for the calculation.

Moreover, because in the present example the individual equations are formed into a system and solved through the least-squares method, it is possible to estimate the relative errors with little error, making it possible to obtain a temperature distribution with high accuracy.

### Expanded Examples

While the present invention was explained above in reference to examples, the present invention is not limited by the examples set forth above. The structures and details of the present invention may be modified in a variety of ways, as can be understood by those skilled in the art, within the scope of the present invention.

1: A temperature distribution detecting device, comprising:
a storing portion that stores a combination of two adjacent thermopile array sensors from among a plurality of thermopile array sensors disposed in a space for which a temperature distribution is to be detected;
a detected temperature acquiring portion that acquires detected temperatures from each individual thermopile array sensor;
a temperature difference calculating portion that calculates a temperature difference between detected temperatures, for each combination, between the two thermopile array sensors that structure the combination;
a relative error estimating portion that establishes, for each combination, equations indicating the relationships between the relative error between a reference thermopile array sensor selected as a reference from among the thermopile array sensors and each of the thermopile array sensors and temperature differences calculated for each individual combination, and establishes these equations in a system and solving through the least-squares method to estimate the relative errors; and
a detected temperature correcting portion that corrects, based on the individual relative errors, the detected temperatures by the individual thermopile array sensors, to generate temperature distribution data for the space.

2: The temperature distribution detecting device as set forth in claim 1, wherein:
the detected temperature acquiring portion acquires the individual detected temperatures, detected by the individual detecting elements within each thermopile array sensor, from each individual thermopile array sensor; and
the temperature difference calculating portion, when calculating the temperature difference for each combination, calculates a representative detected temperature in an overlapping region wherein the temperature detecting ranges of thermopile array sensors that are combined partially overlap each other, through statistical processes on the individual detected temperatures acquired from the applicable thermopile array sensor, for each individual thermopile array sensor, and then calculates a temperature difference between the representative detected temperatures between the two thermopile array sensors that structure the combination.

3: A temperature distribution detecting method, comprising:
a storing step of storing by a storing portion a combination of two adjacent thermopile array sensors from among a plurality of thermopile array sensors disposed in a space for which a temperature distribution is to be detected;
a detected temperature acquiring step of acquiring by a detected temperature acquiring portion detected temperatures from each individual thermopile array sensor;
a temperature difference calculating step of calculating by a temperature difference calculating portion a temperature difference between detected temperatures, for each combination, between the two thermopile array sensors that structure the combination;
a relative error estimating step of establishing by a relative error estimating portion, for each combination, equations indicating the relationships between the relative error between a reference thermopile array sensor selected as a reference from among the thermopile array sensors and each of the thermopile array sensors and temperature differences calculated for each individual combination, and establishing these equations in a system and solves the system through the least-squares method to estimate the relative errors; and
a detected temperature correcting step of correcting by a detected temperature correcting portion, based on the individual relative errors, the detected temperatures by the individual thermopile array sensors, to generate temperature distribution data for the space.
